(19) United States
(12) Patent Application Publication
(10) Pub. No.: US 2021/0400453 A1
(43) Pub. Date: Dec. 23, 2021

(54) Graphic-Link Interaction: A System and Modality for Verified Contact Information Sharing

(71) Applicant: Ezequiel Davila, Lawrence, MA (US)

(72) Inventor: Ezequiel Davila, Lawrence, MA (US)

(21) Appl. No.: 16/904,537

(22) Filed: Jun. 17, 2020

(51) Int. Cl. H04W 4/80; H04W 8/22; H04M 1/725; G06F 3/01; H04W 4/02

(52) U.S. Cl. CPC H04W 4/80; H04W 8/22; H04W 4/02; H04M 1/72544; G06F 3/017; H04M 1/7253

(57) ABSTRACT

It is my privilege and honor to disclose the current invention as an affordable public health utility which supports widely enforced social distancing standards during the Covid-19 Pandemic.

The contained disclosure enables smart device users to engage one another, in conjunction, and according to their environments confidently, conveniently, and efficiently via low energy peripheral wireless connectivity potentials (currently standard) within the relevant technical field.

The contained disclosure enables a universal lexicon and modality for smart device users to share and receive infinite and dynamic contact information. The invention disclosed is so vastly applicable, due to its physical convenience, that it may, if accepted, shape communications and consumer culture(s) globally into the future.

### BACKGROUND OF THE INVENTION

### Field of the Invention

The present invention relates to, Contact Management, Information Systems, Verification Systems, Accessible Communication, Accessible Markets, Advertisement, Smart Device Technology, Wearable Technology, and Low-Energy Peripheral Wireless Connectivity, and Social-Distancing Technology.

Other U.S. Patent codes which could relate to this invention include:
072 Machine Element or Mechanism
079 Button Making
081 Tools
221 Article Dispensing
307 Electrical Transmission or Interconnection systems
326 Digital Logic Circuitry
327 Miscellaneous active electrical nonlinear devices, circuits and systems
340 Communications: electrical
341 Coded data generation or conversion
342 Communication: directive radio wave systems and devices
345 Computer Graphics processing and selective visual display systems
346 Recorders
347 Incremental Printing of symbolic information
365 Static Information storage and retrieval
369 Dynamic Information Storage and retrieval
370 Multiplex Communications
455 Telecommunications
709 Electrical Computers and digital processing systems: multicomputer data transferring
712 Electrical computer and digital processing systems: processing architectures and instruction processing
715 Data processing: presentation processing of document operator interface processing, and screen saver display processing
717 Data processing: software development, installation, and management
718 Electrical computers and digital processing systems: virtual machine task or process management or task management control
719 Electrical computers and digital processing systems: interprogram communication or interprocess communication (ipc)
726 Information Security
D14 Recording, communication, or information retrieval equipment
D19 Office Supplies; artists and teacher materials
D20 Sales and advertising equipment

### DESCRIPTION OF RELATED ART

Contact information management is a daily task for most people living in modern society. Today, contact management applications are used to store contact data locally on a cell phone, computer, or over a cloud. Conventionally, in-person or live contact information sharing takes place via contact documents (i.e business cards, brochures, flyers, other advertising) or verbal interactions. Given the disposability and inherent waste of these, usually paper, contact documents, and the dwindling natural resources from which they arise, a paperless method for sharing contact data is necessary. The conventional method of sharing contact information verbally is not always convenient for people and can deter a person from sharing contact information despite actually being interested in doing so.

The existing Virtual Contact File (.vcf) used to transport contact data fails; due to its exclusionary format between user-device operating systems (ex. Android—iPhone), its limitation to being sent as a message over a network connection, and further, because it does not serve for making acquaintance, but rather, only for sharing an outside party's contact information with a party to which the user must already have established contact with. A universal format for immediate contact information sharing is necessitated by the shortcomings of the Virtual Contact File and miscommunications between different smart device operating systems. Further, persons with varying levels of ability in society, such as language barriers or hearing impairment, necessitate technology which can empower them to easily engage in contact information sharing.

### SUMMARY OF THE INVENTION

Therefore, it is an object of the present invention to render regular, long term, or permanent data related to contact and communications, in a uniform, more energy efficient, and accessible package: The Contact Data Set.

It is another object of the invention to provide a secure, parallel (visual-virtual) verification method for facilitating contact information sharing, and to establish a visual-gesture release and/or acceptance of user permissions via a (universalizing) common application prior to the respective accessibility and storage of the respective contact data on user device(s).

Further, it is another object of the invention to establish an intuitive visual-gesture lexicon composed of Graphic-Link Symbols displayed in conjunction with a visual identifier (session RGB value) for users to distinguish themselves via their own registered smart devices when sharing (releasing and/or accepting permissions to) contact information virtually via low energy, peripheral wireless read-write operations.

Furthermore, It is yet another object of the invention to accommodate disparities in accessibility due to physical impairment, cellular or network service, and device incompatibility (such as Android, Iphone, Blackberry). Specifically, the PMID protocol aligns with and can be programmed to leverage several existing peripheral wireless connection technologies such as Bluetooth LE, RSSI, Multipair, Bonjour or RFID.

Finally, an important object of this invention is to enable people to connect within appropriate social distance proximity during the Covid-19 Pandemic.

### BRIEF DESCRIPTION OF DRAWINGS

FIG. 0|(Page 1 of Drawings): Cover Page

FIG. 1|(Page 2 of Drawings): Background Art

FIG. 2|(Page 3 of Drawings): Symbols

FIG. 3|(Page 4 of Drawings): Registration+Setup for Graphic-Link Interactions

FIG. 4|(Page 5 of Drawings): Contact Data Set, PMID, and Information Management

FIG. 5|(Page 6 of Drawings): Graphic-Link Interaction Symbols and Specification Buttons

FIG. 6|(Page 7 of Drawings): List of Common Application Operations Pertaining to Graphic-Link Interactions

FIG. 7|(Page 8 of Drawings): Peripheral Wireless Proximity Representation

FIG. 8|(Pages 9-16 of Drawings): [Save-Drop] Graphic-Link Interaction; Graphic-Link Gesture

FIG. 9|(Page 17-21 of Drawings): [Swap] Graphic-Link Interaction; Graphic-Link Gesture

FIG. 10|(Page 22-25 of Drawings): [Swap-Drop] Graphic-Link Interaction

FIG. 11|(Page 26-29 of Drawings): Multiple, Simultaneous Graphic-Link Interactions and Gestures

FIG. 12|(Page 30 of Drawings): Summary of GLI System

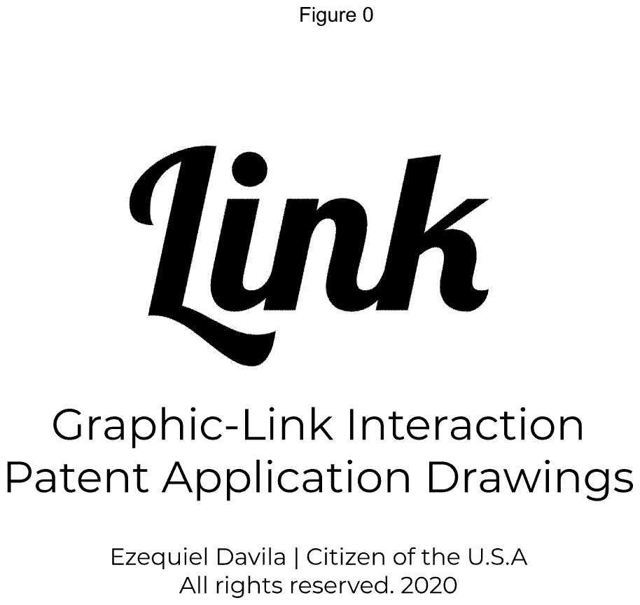

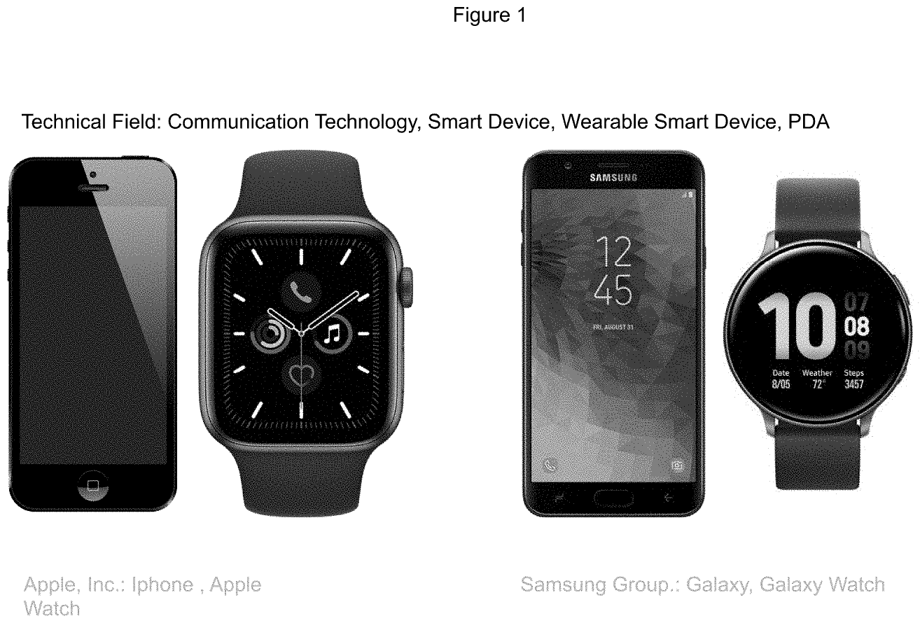

### DETAILED DESCRIPTION OF THE INVENTION AND ITS EMBODIMENTS

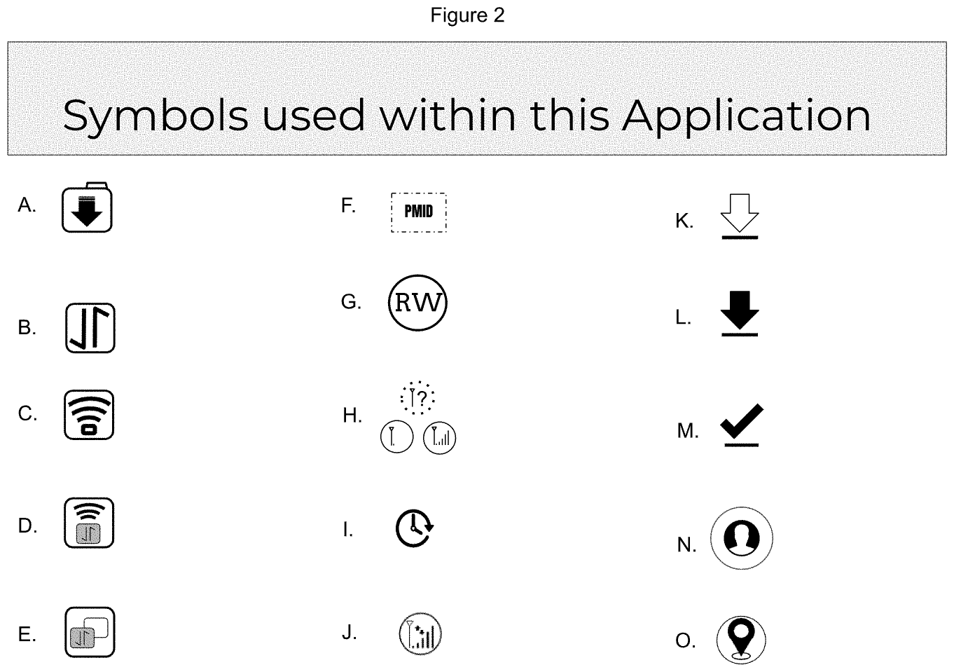

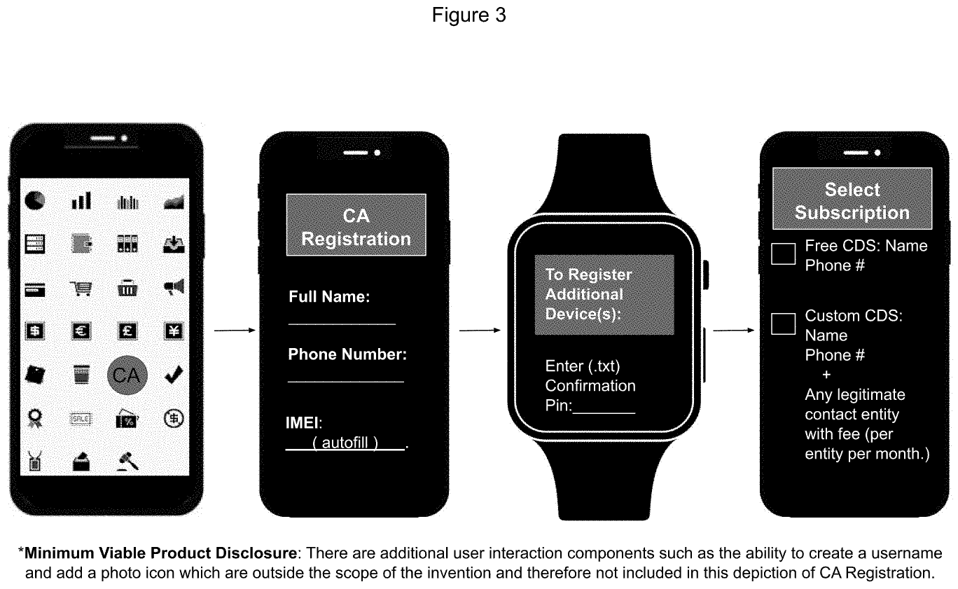

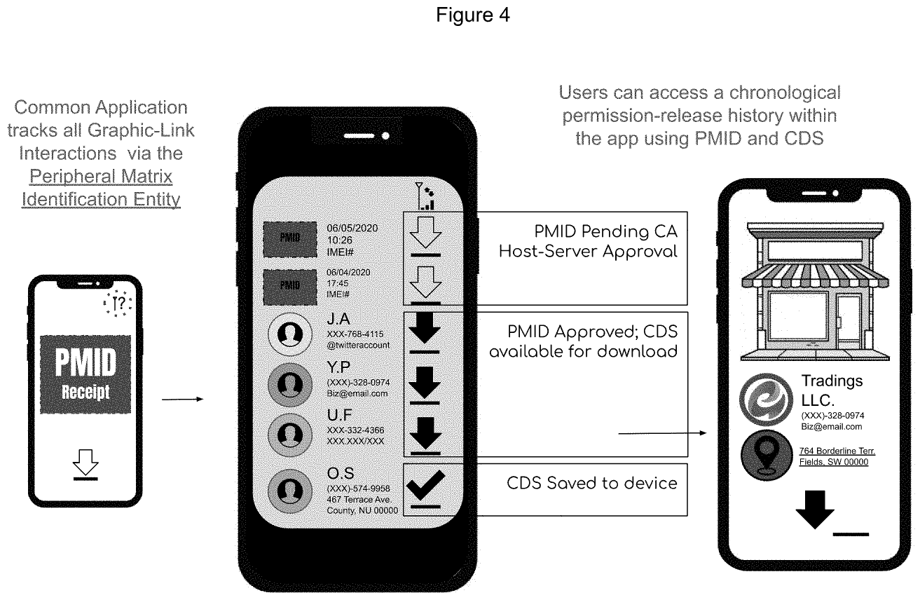

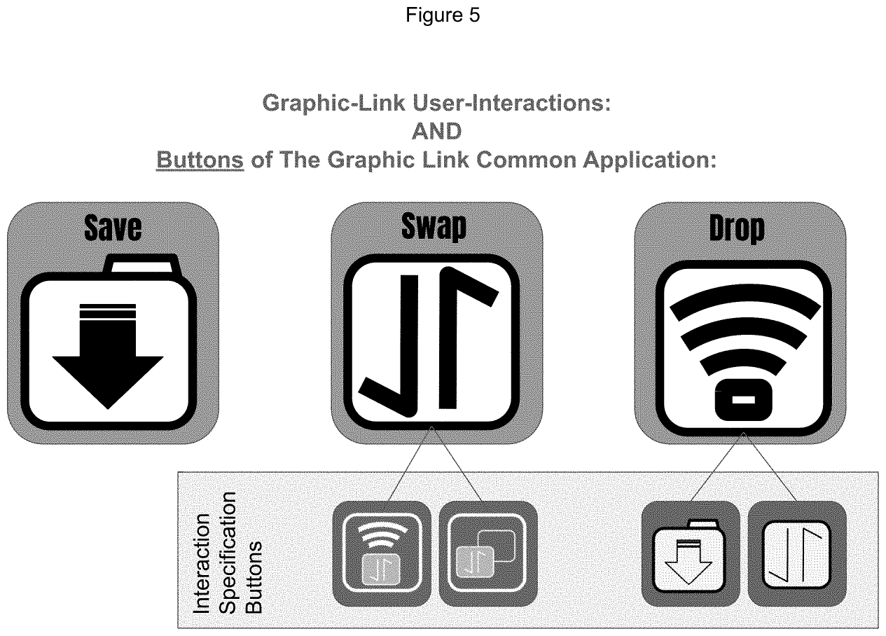

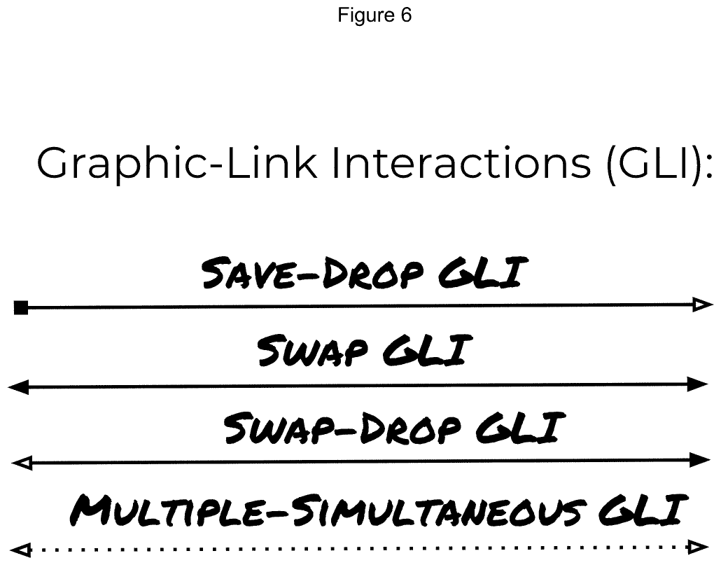

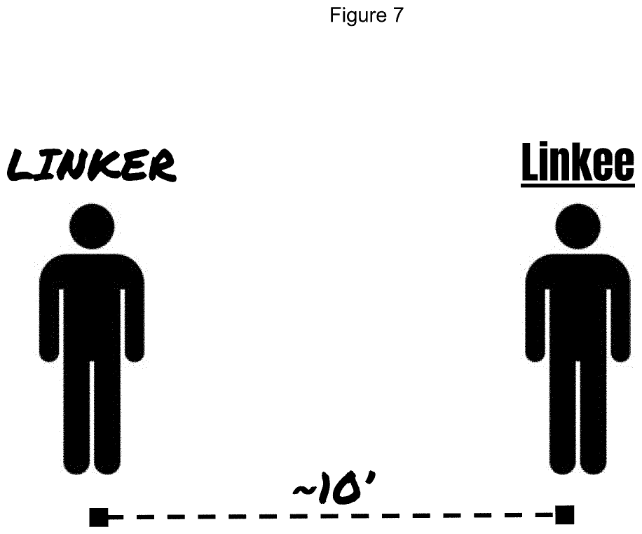

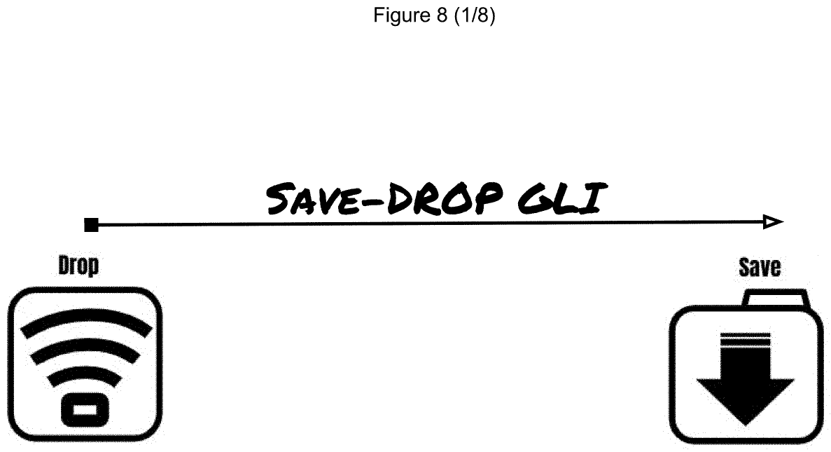

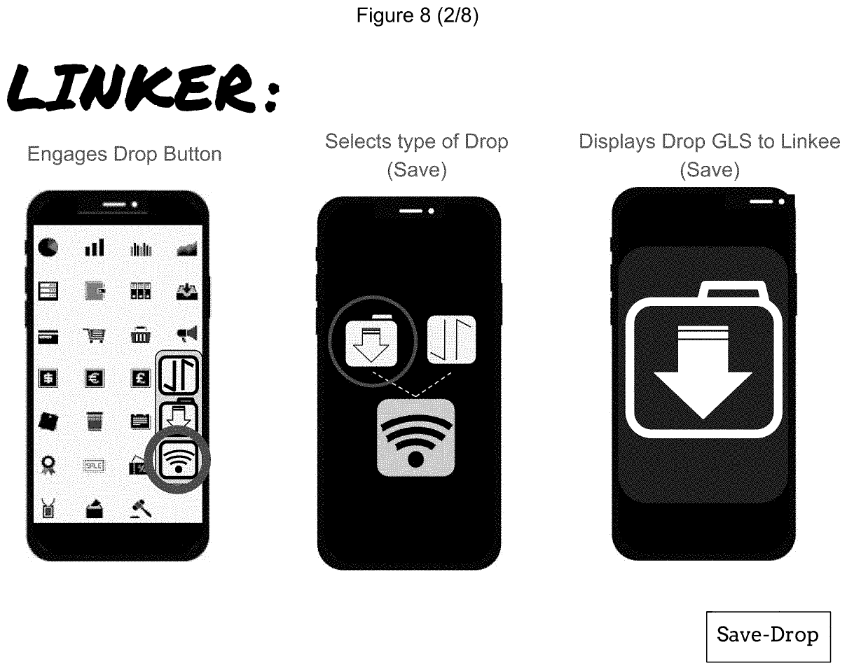

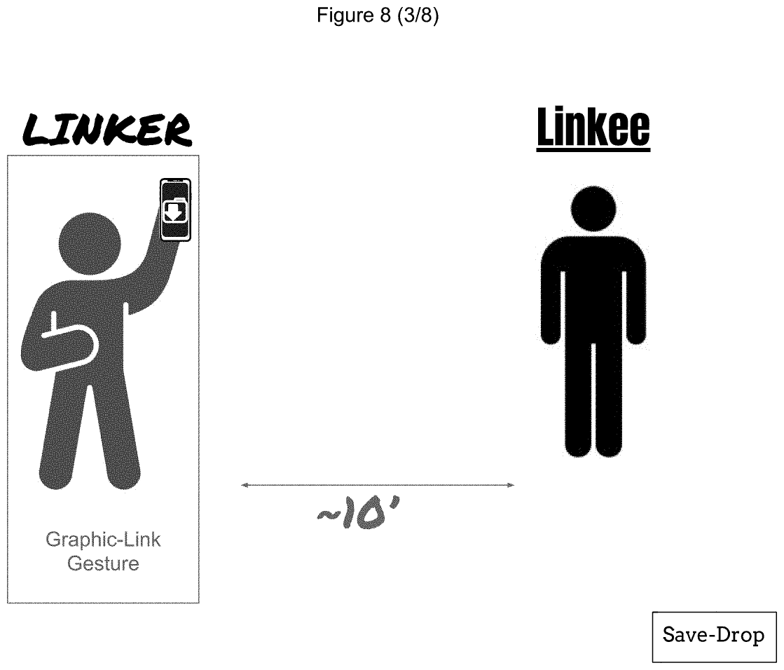

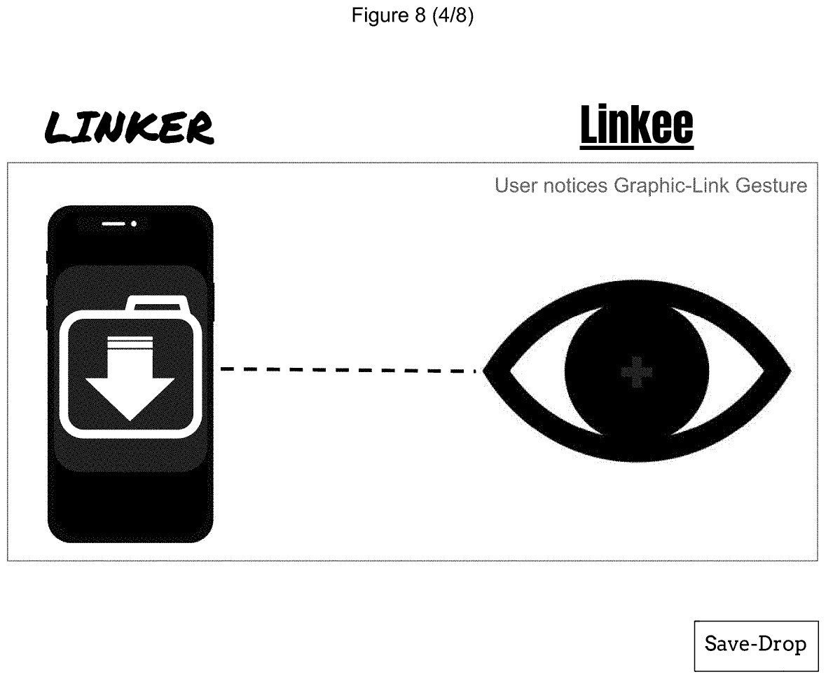

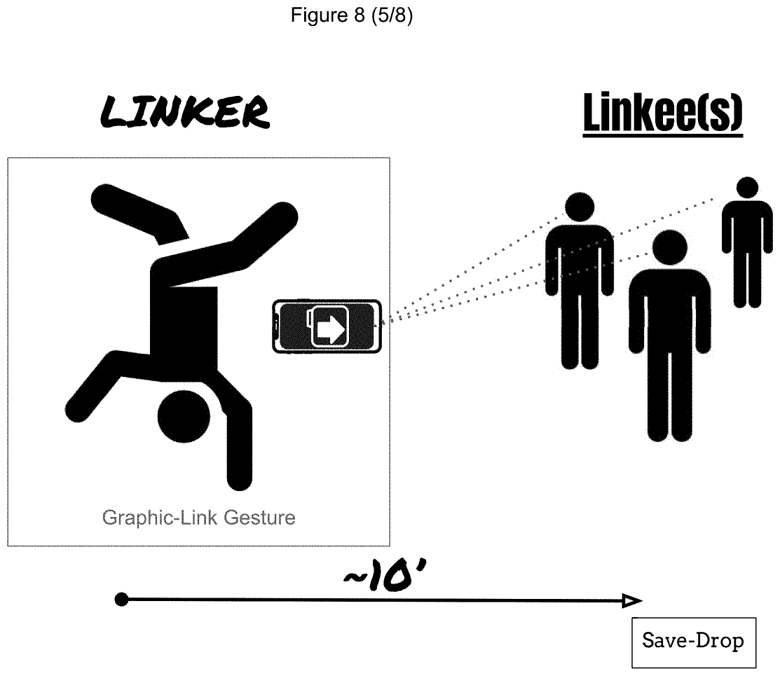

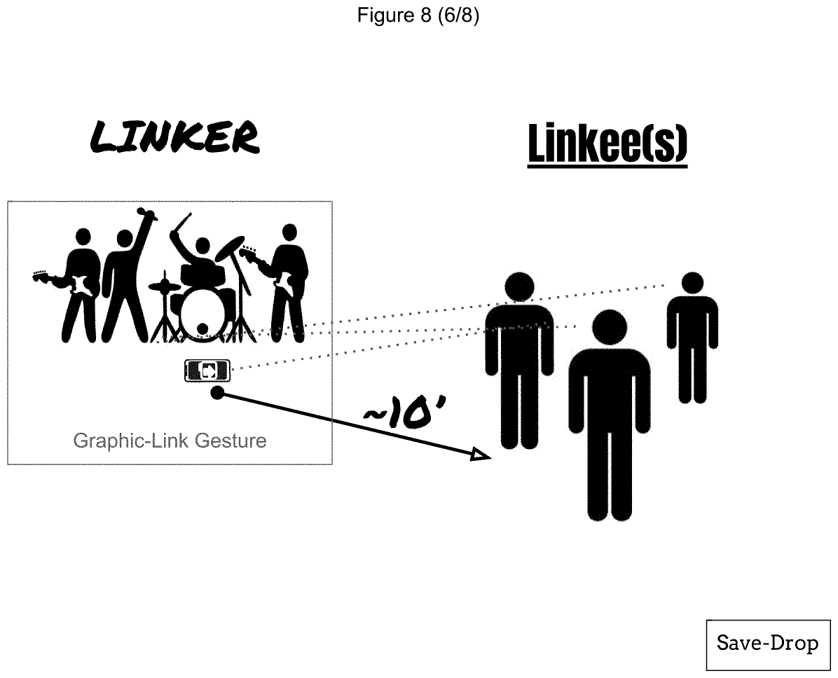

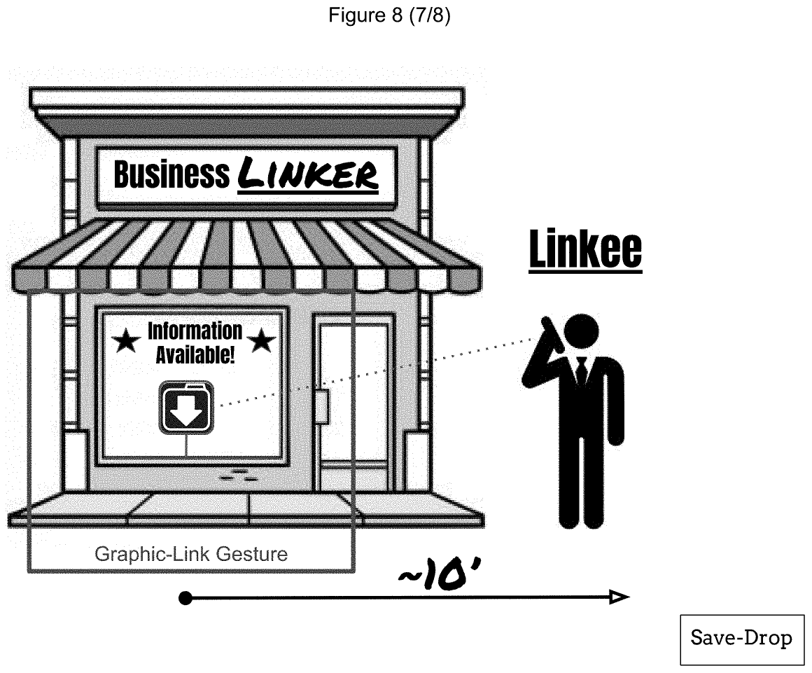

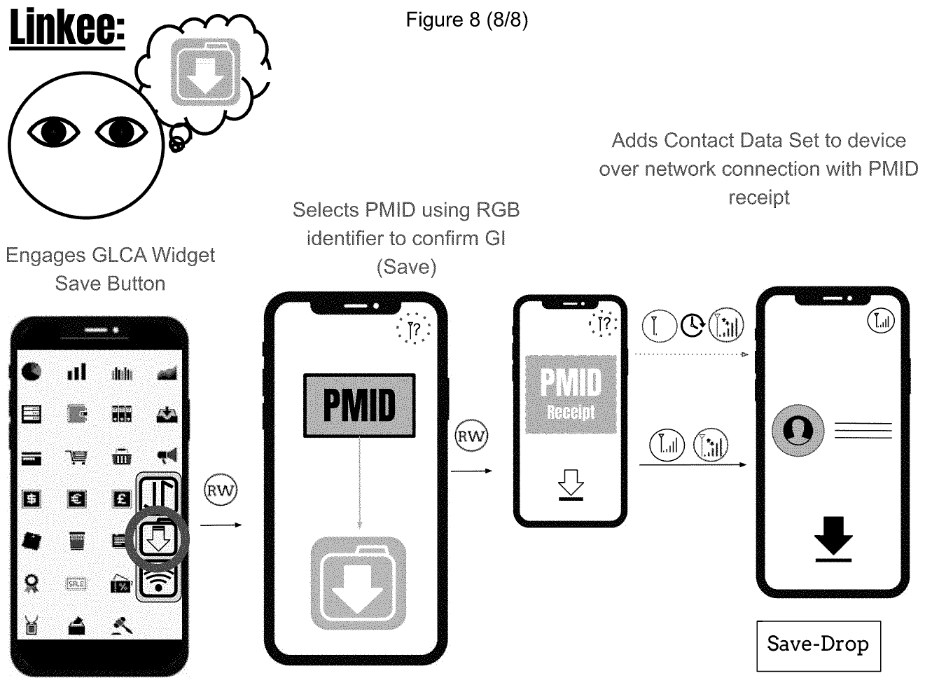

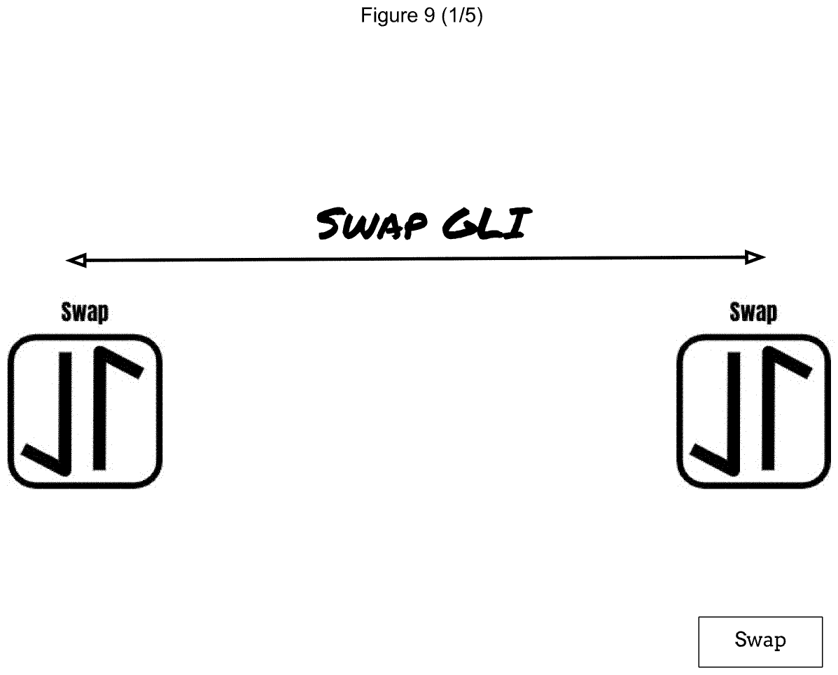

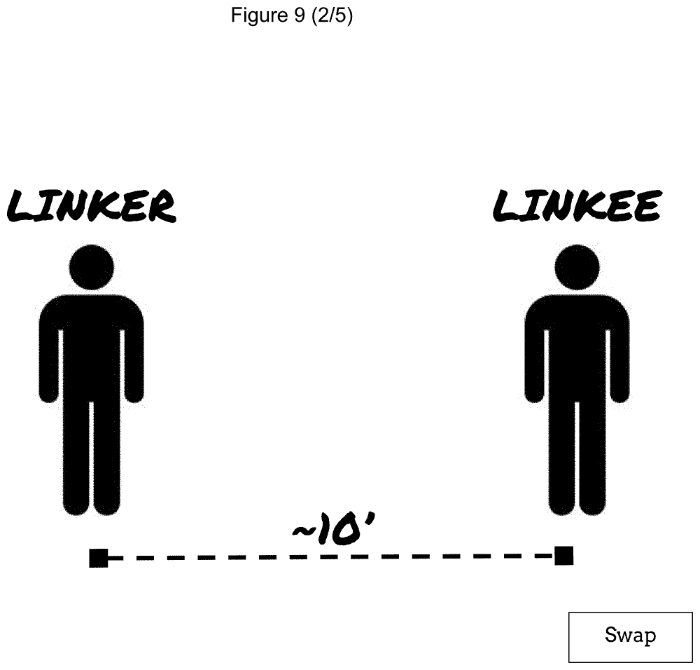

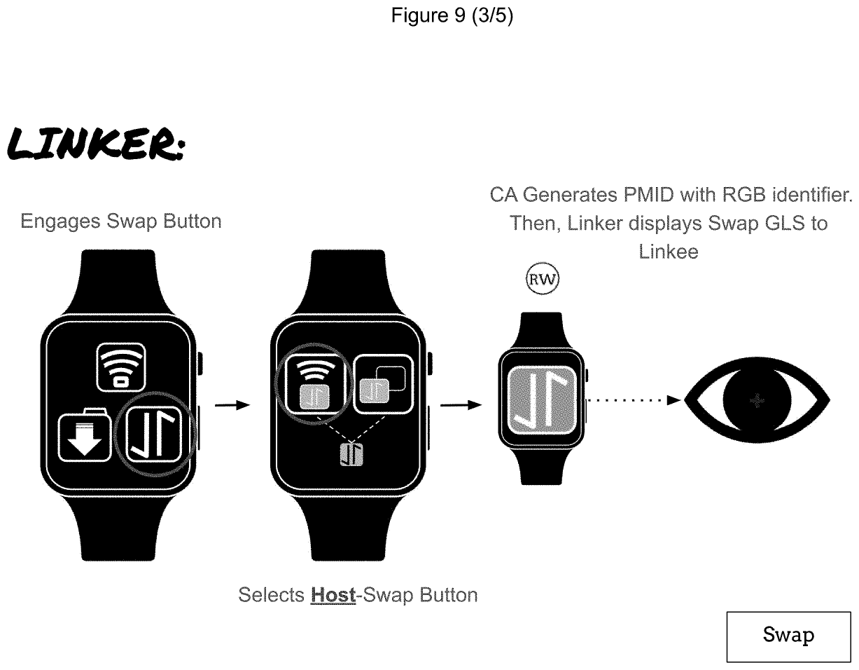

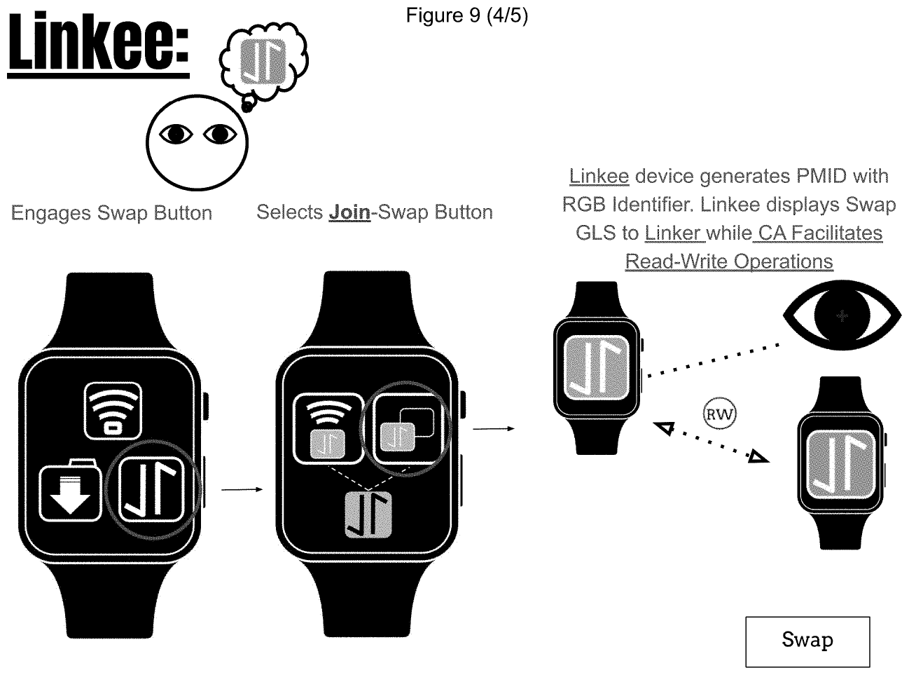

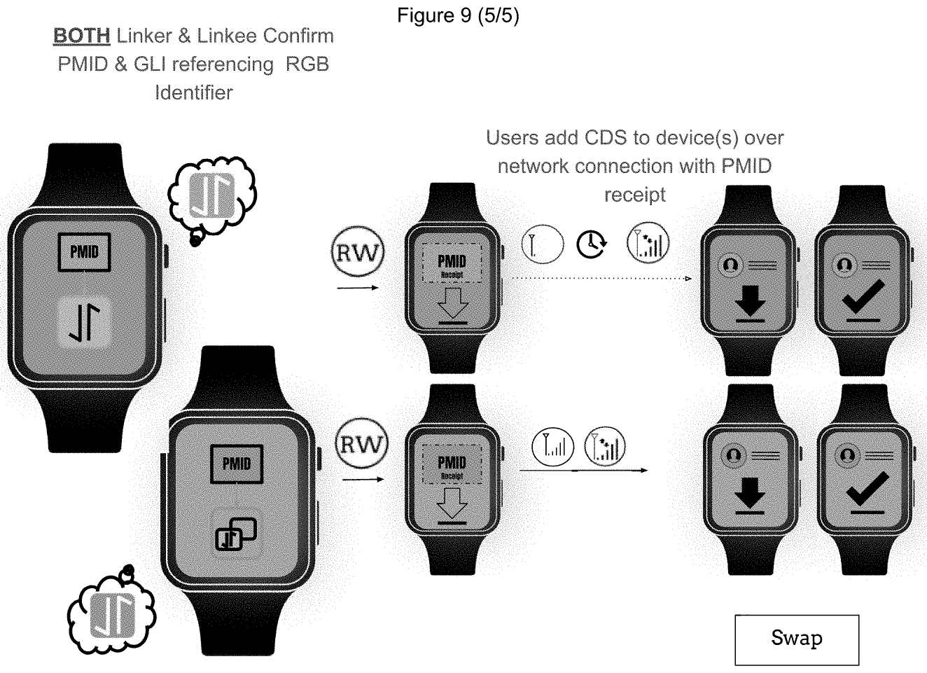

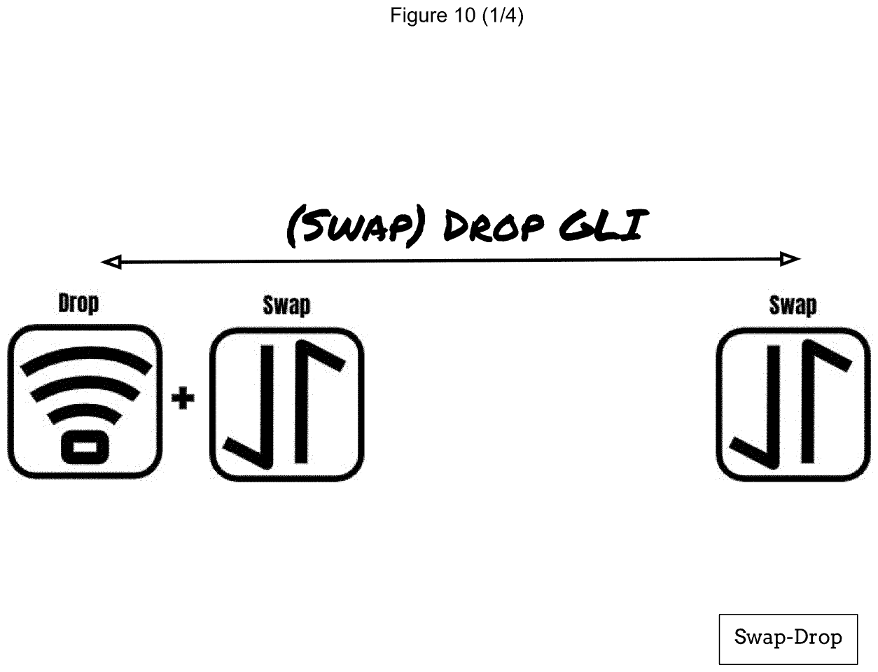

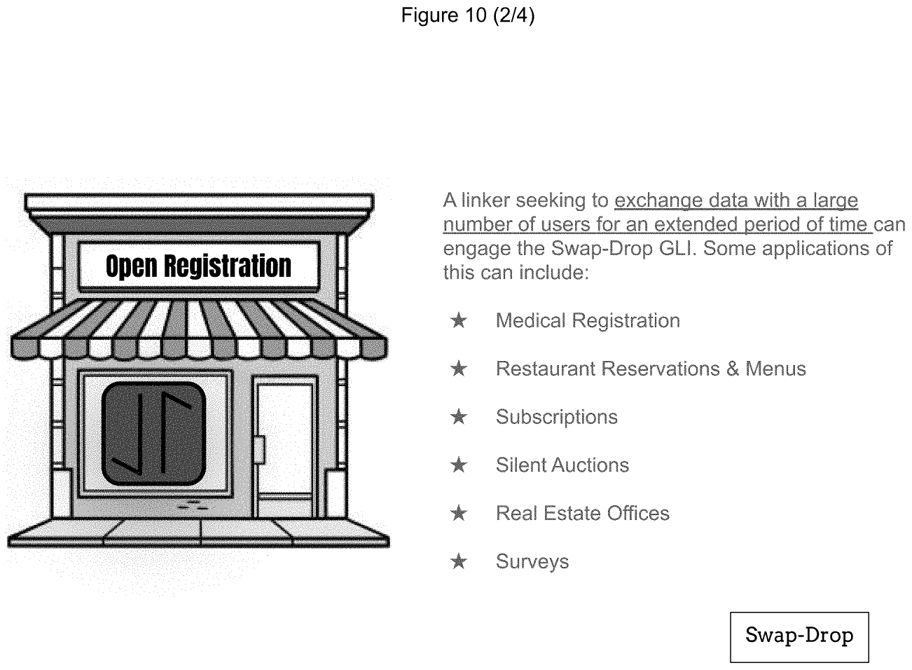

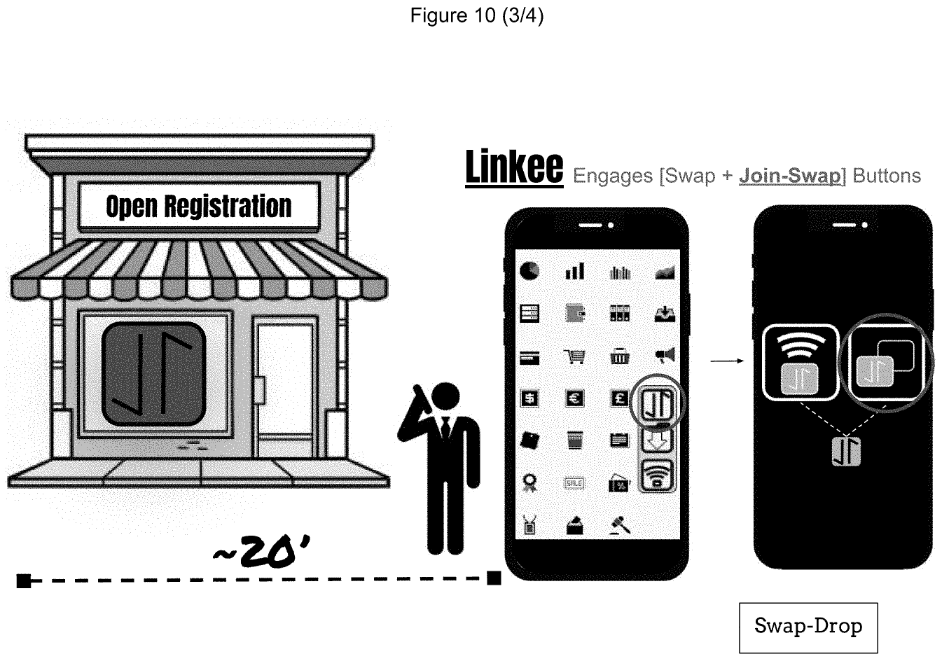

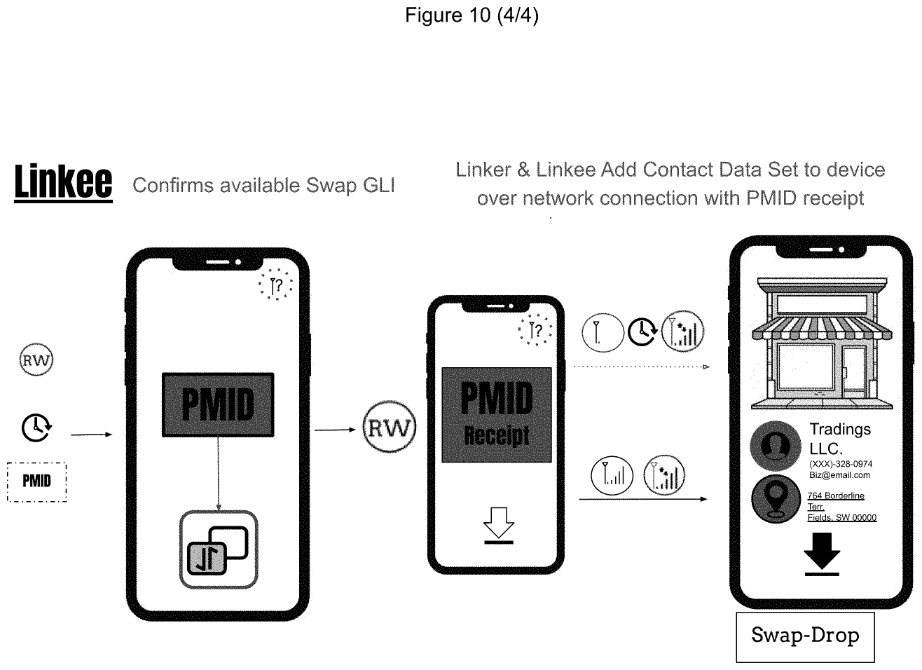

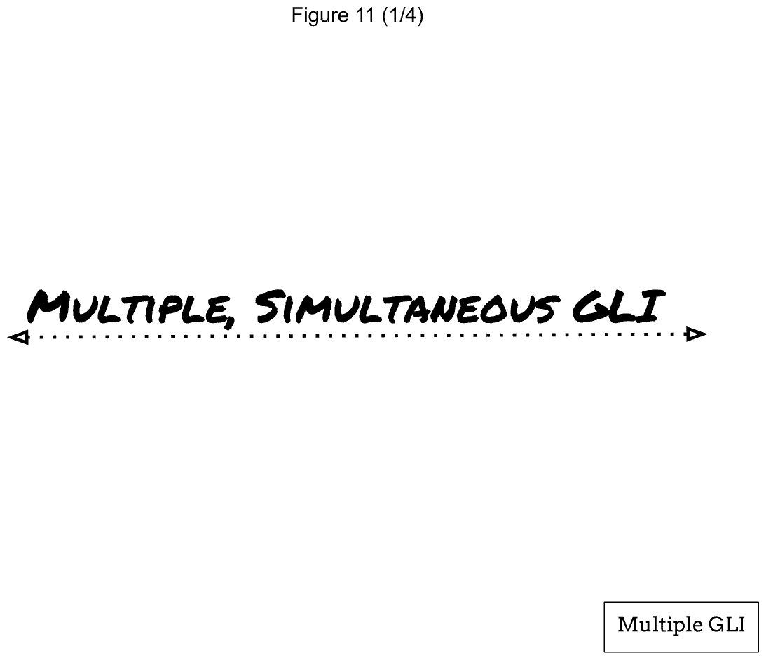

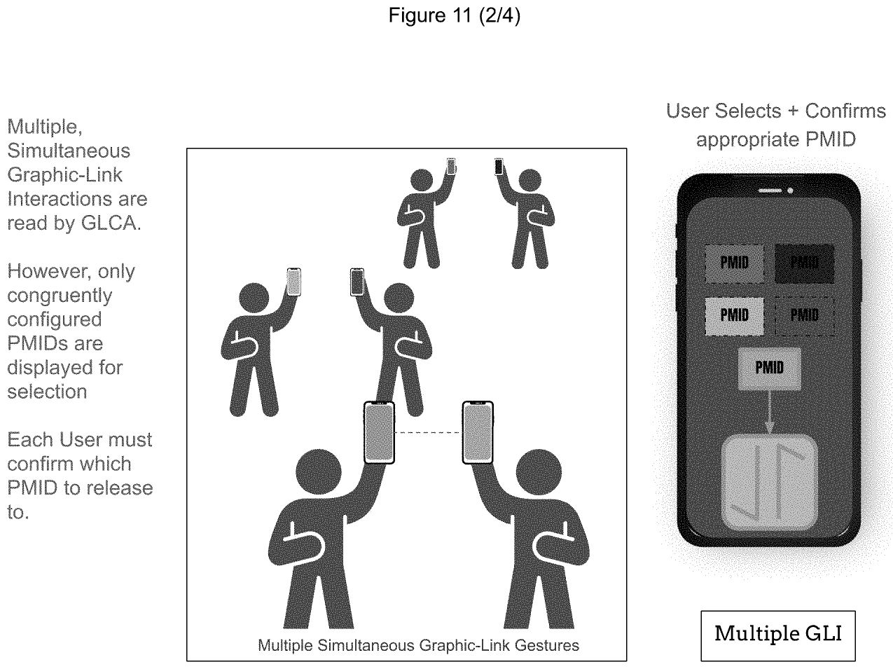

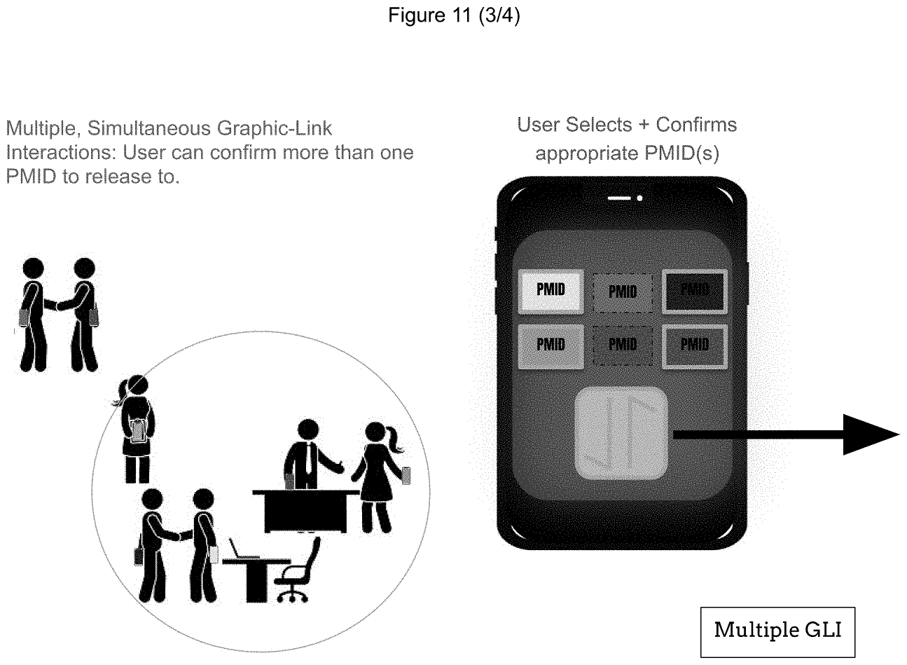

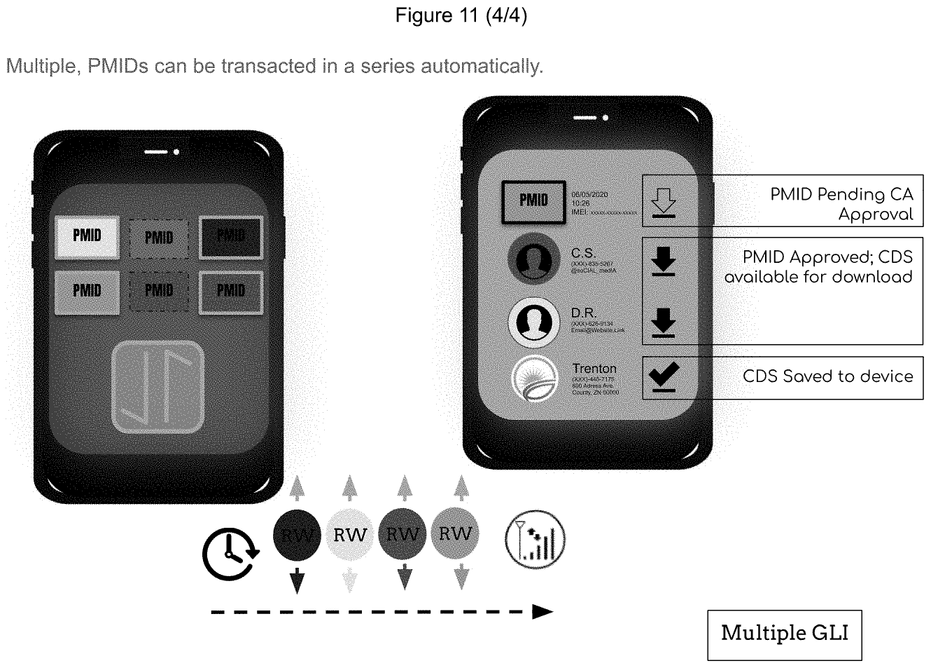

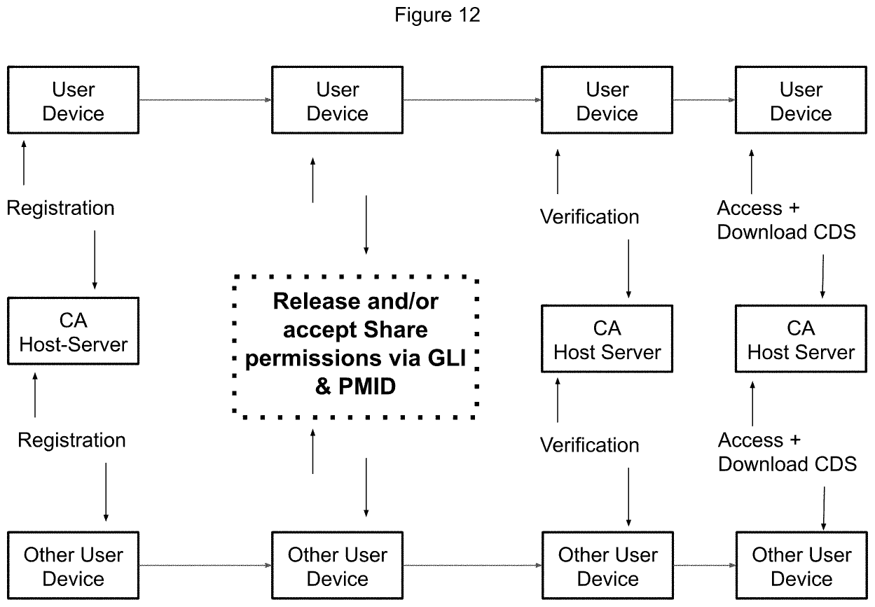

The Graphic-Link Interaction (GLI) is a dual-live (visual-virtual) verification gesture and modality for securely releasing and/or accepting permissions related to contact information via smart device peripheral wireless read-write operations; wherein a “Linker” is the user or licenced entity initiating the permission-release procedure described herein and the “Linkee” is the user who opts into the permission-release accordingly; and wherein contact information sharing is stratified into three phases: registration (see FIG. 3), permission-release (see FIGS. 5-11), and download (See FIGS. 4-11), inherently advancing the release of permissions related to contact information prior to the accessibility of that data (by a user device) with the exception of the device specific number {IMEI or APL ID Number} functioning within a PMID as a virtual identifier for confirmations.
Corresponding structural elements include:
1. Contact Data Set (CDS) refers to the finite data registered between a user and the Common Application, intended for sharing via Graphic-Link Interactions, containing, minimally, [Name, Phone Number, and Device ID Number {IMEI or APL ID}], however, also customizable to include additional contact or payment information (ex. email, usernames, weblinks, PayPal ID, social media, GPS Coordinates, . . . etc)
2. Graphic-Link Symbol(s) (GLS) are the lexicon of agents and articles inciting any Graphic-Link Interaction; the GLS is a visual symbol and identifier generated, with a PMID, for display, broadcast, or other gesture meant to incite the release and/or acceptance of share permissions related to a Contact Data Set. The GLS can be generated and displayed on devices without a network connection. (See FIGS. 5-11)
3. Graphic-Link Gesture(GLG): Refers to the visual-gestures made by or alongside the display of a GLS, and may be constituted by anything ranging from simply showing a GLS displayed on a smart device, to displaying a GLS via custom hardware in a show window for public engagement. (See FIGS. 8-11)
4. Common Application (CA) is the universal smart device application with a central host-server for the facilitation and verification of Graphic-Link Interactions; wherein users can register a Contact Data Set, release and accept permissions related to Contact Data Set sharing, and access, with the option to download, Contact Data Set(s); (See FIGS. 2-11)
   Buttons of the Common Application: engaging a CA Button initiates the display of the appropriate Graphic-Link Symbol and parallel PMID read-write operation via peripheral wireless communication.
      → Drop Button. A registered user intends to release and promote their Contact Data Set as a Linker in a public setting for an extended period of time to any user passing within the proximal radius (˜10′) to Save or Swap CDS(s) via the CA. (See FIGS. 8 & 10)
         CA displays respective GLS on the screen of the smart device
         CA facilitates corresponding PMID read-write operations
      → Save Button. A user, already incited by a proximal Save Graphic-Link Symbol, and therefore the Linkee, intends to save the available CDS for immediate interaction or future reference. (See FIG. 8)
         CA completes respective PMID read-write operation
      → Swap Button. A user intends to initiate or opt into, via Host-Swap & Join-Swap Specification Buttons respectively, a CDS exchange with a proximal user, group of users, or otherwise licensed entity. (See FIGS. 9-11)
         CA displays Swap GLS on the screen of the smart device
         CA completes respective PMID read-write operation(s)
         User selects and confirms, via the CA, the PMID receipt(s) matching the visually identifiable characteristic (color) of the Graphic-Link Symbol visible to them.
      → Specification Buttons. A user intends to orient (or align) their device for a GLI; the user (Linker or Linkee) shapes their PMID read-write orientation by engaging specification buttons. These specifications are used by the CA prior to or during GLI to orient the generated PMID with conditions for the purpose of distinguishing and minimizing peripheral devices displayed to the user for selection and confirmation.
         Save-Drop Specification Button displays a Save GLS on device AND generates a PMID oriented for express release of a CDS during an extended period of time, NOT requiring a confirmation from the Linker for each Linkee device a PMID is “Saved” to.
         Swap-Drop Specification Button Displays Swap GLS on device AND generates a PMID oriented for express release AND acceptance of CDS(s) during an extended period of time, NOT requiring a confirmation from the Linker for each Linkee device a PMID is “Swapped” with.
         Host-Swap Specification Button Displays Swap GLS on device AND generates a PMID oriented for release AND acceptance of a CDS during a limited period of time (approximately 15 seconds), requiring a confirmation from the Linker for each Linkee device the PMID is to be “Swapped” with.
         Join-Swap Specification Button Displays Swap GLS on device AND generates a PMID oriented for release AND acceptance of a CDS during a limited period of time (approximately 15 seconds), requiring a confirmation from the Linkee for each Linker device a PMID is to be “Swapped” with.
5. Peripheral Matrix Identification (PMID) refers to the encoded, device-specific, receipt-message generated and read by the Common Application (CA) (using an official device number such as IMEI or APL ID) during and according to various GLI, to facilitate, in parallel to the display of a Graphic-Link Symbol, a record of the release and/or acceptance of CDS permissions between users in real time—regardless of the user device's network (data) connection status.
   The PMID is generated instantly upon engaging a Graphic-Link Interaction Button of the Common Application: using the device number {IMEI or APL ID}, time, date, and intended GLI; the CA generates a Graphic-Link Symbol expressing (tied to) a visual identifier (minimally, RGB Value) to be gestured with, noticed, and matched on the CA by the intended party. The unique visual identifier is an integral part of the CA-PMID dual-live (visual-virtual) verification procedure as it is a non-liable entity which can be transcoded (read-written) via peripheral wireless connection among user devices in order to express distinction between them. Moreover, the CA-PMID protocol prevents CDS interception (phishing) during GLI.
   If a user confirms a GLI with no network connection available to the user device, The PMID is stored locally within the CA on the user device. Upon network availability, the CA will communicate with the Common Application Host-Server to verify (using the stored PMID) that pertinent device information aligns with user registrations and appropriate licenses. Once the PMID has been verified by the CA Host-Server, the respective CDS becomes accessible and available for download from the host-server onto the user device. Moreover, a CDS can be downloaded via the CA using a PMID at any time away from the moment it was received, or not at all.

1. The Graphic-Link Interaction (GLI) as a dual-live (visual-virtual) verification modality for releasing and/or accepting share permissions related to a Contact Data Set (CDS) prior to any granted access or transcription of said data; wherein a lexicon of Graphic-Link Symbols (GLS) (defined within this application as buttons or visual signifiers) can be broadcasted or displayed to incite contact information sharing via a Common Application (CA); wherein the CA, installed on a user device, and a registered user engage the dual-live verification process consisting of Graphic-Link Gesture(s) (GLG) and CA-PMID confirmation procedure, wherein a user and the CA display a GLS with a visual identifier (such as an RGB value), and wherein, parallel to the user's GLG, The Common Application executes a Peripheral Matrix Identification (PMID) read-write operation via peripheral-wireless connectivity to verify, execute, and record the respective release and/or acceptance of Contact Data Set share permissions.

2. The Common Application (CA) of claim 1, as the unifying facilitation software and button system for releasing and/or accepting share permissions related to a Contact Data Set via peripheral wireless connection; and the means through which contact information becomes available to a user following appropriate verification of the PMID over a network connection.

3. The Contact Data Set (CDS) of claim 1, as a licensable set of regular, long term, or permanent information related to contact and communications, including minimally (and tied to), Name, {IMEI or APL ID}, and Phone Number, however, customizable to include any additional and legitimate contact details.

4. The Peripheral Matrix Identification (PMID) of claim 1, as an encoded {IMEI or APL ID}-specific, receipt-message format for verifying, executing, and recording the release and/or acceptance of CDS permissions between users in real time—regardless of the user device's network (data) connection status; The PMID is generated, with a devices {IMEI or APL ID}-Number, date, time, intended GLI, and unique visual identifier (such as an RGB value) to be expressed by the user's GLS, and, if applicable, on peripheral devices oriented congruently for the same GLI.

5. The Graphic-Link Symbol (GLS) of claim 1, as any visual symbol displayed, broadcasted, or otherwise gestured with in order to incite the release and/or acceptance of share permissions related to a Contact Data Set. (See Drawings)

6. The Graphic-Link Gesture (GLG) of claim 1, as any visual-gesture made by or alongside the display of a GLS, intending inherently to incite the release and or acceptance of a CDS
